(19) United States
(12) Patent Application Publication
(10) Pub. No.: US 2006/0007346 A1
(43) Pub. Date: Jan. 12, 2006

(54) Image capturing apparatus and image capturing method

(76) Inventors: Kenji Nakamura, Takatsuki-shi (JP); Masahiro Kitamura, Osaka-shi (JP); Shinichi Fujii, Osaka-shi (JP); Yasuhiro Kingetsu, Sakai-shi (JP); Dai Shintani, Izumi-shi (JP); Tsutomu Honda, Sakai-shi (JP)

Correspondence Address: SIDLEY AUSTIN BROWN & WOOD LLP, 717 NORTH HARWOOD, SUITE 3400, DALLAS, TX, 75201, US

(21) Appl. No.: 11/059,428

(22) Filed: Feb. 16, 2005

(30) Foreign Application Priority Data
Jul. 12, 2004 (JP) JP2004-204625

(51) Int. Cl. H04N 5/235

(52) U.S. Cl. 348/362

(57) ABSTRACT

The image capturing apparatus can perform image capturing at a high frame rate higher than a frame rate used for displaying a moving image. In image capturing with flashlight in the image capturing apparatus, the high frame rate is set and three images are successively captured while increasing the light emission amount of the flashlight in order. A region in the lower portion of the image captured first, a region in the center portion of the image captured second, and a region in the upper portion of the image captured third, the exposure level being proper in each of these regions, are extracted and combined. As a result, a high-quality synthetic image in which exposure is proper from the front side to the deep side in image capturing in a room can be generated.

This application is based on application No. 2004-204625 in Japan, the contents of which are hereby incorporated by reference.

### BACKGROUND OF THE INVENTION

1. Field of the Invention

The present invention relates to an image capturing apparatus for generating an image of a subject.

2. Description of the Background Art

An image capturing apparatus such as a digital camera performs image capturing while compensating an insufficient exposure amount by using an electronic flash.

In the image capturing using an electronic flash, although an exposure amount on a main subject becomes proper, a subject positioned at an image capturing distance different from that of the main subject is often overexposed or underexposed. This happens because a reflection light amount is too large due to short image capturing distance or a reflection light amount is too small due to long image capturing distance.

With regard to this point, there is a technique which obtains an image in which both of a main subject and a background are properly exposed by synthesizing an image obtained with flashlight and an image obtained without flashlight in a night view image capturing mode (see Japanese Patent Application Laid-Open No. 2003-87645).

According to the technique disclosed in the above publication, however, image capturing without flashlight accompanies long-time exposure. Consequently, a camera shake easily occurs, the possibility of occurrence of a blur of a subject is high, and it is difficult to synthesize images with high precision. In addition, the technique is directed to so-called night view image capturing and cannot be applied to image capturing of a human being in a room or the like.

### SUMMARY OF THE INVENTION

The present invention is directed to an image capturing apparatus.

According to the present invention, the image capturing apparatus having a display device capable of displaying an image comprises: (a) an image capturing device which generates an image of a subject; (b) a driver which sequentially drives the image capturing device at timings based on a high frame rate higher than a display frame rate used at the time of displaying a moving image on the display device; (c) an image capturing controller which sequentially captures two or more images while changing an image capturing condition each time the image capturing device is driven by the driver; and (d) a synthesizer which synthesizes the two or more images, thereby generating a synthetic image, wherein with respect to changing in the image capturing condition by the image capturing controller, the image capturing condition is changed in two or more levels. Therefore, a proper image in which, for example, all of subjects are properly exposed can be obtained.

In a preferred embodiment of the present invention, the image capturing apparatus further comprises: (e) an emission setting part which sets a light emission amount of an electronic flash in the two or more levels, wherein the image capturing condition includes a condition regarding the light emission amount of an electronic flash. Consequently, an image in which all of subjects are properly exposed can be obtained.

The present invention is also directed to an image capturing method.

Therefore, an object of the present invention is to provide an image capturing technique capable of obtaining an image in which all of subjects are properly exposed irrespective of image capturing distances in image capturing with flashlight.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing an image capturing apparatus according to a preferred embodiment of the present invention;

FIG. 2 is a rear view of the image capturing apparatus;

FIG. 3 is a diagram showing functional blocks of the image capturing apparatus;

FIGS. 4A to 4D are diagrams illustrating moving image capturing operation and playback operation of the image capturing apparatus;

FIG. 5 is a diagram illustrating image capturing with flashlight in the image capturing apparatus;

FIGS. 6A to 6C are diagrams illustrating images captured by the image capturing with flashlight;

FIG. 7 is a diagram showing a synthesized image; and

FIG. 8 is a flowchart showing operations of the image capturing with flashlight in the image capturing apparatus.

### DESCRIPTION OF THE PREFERRED EMBODIMENTS

Configuration of Main Part of Image Capturing Apparatus

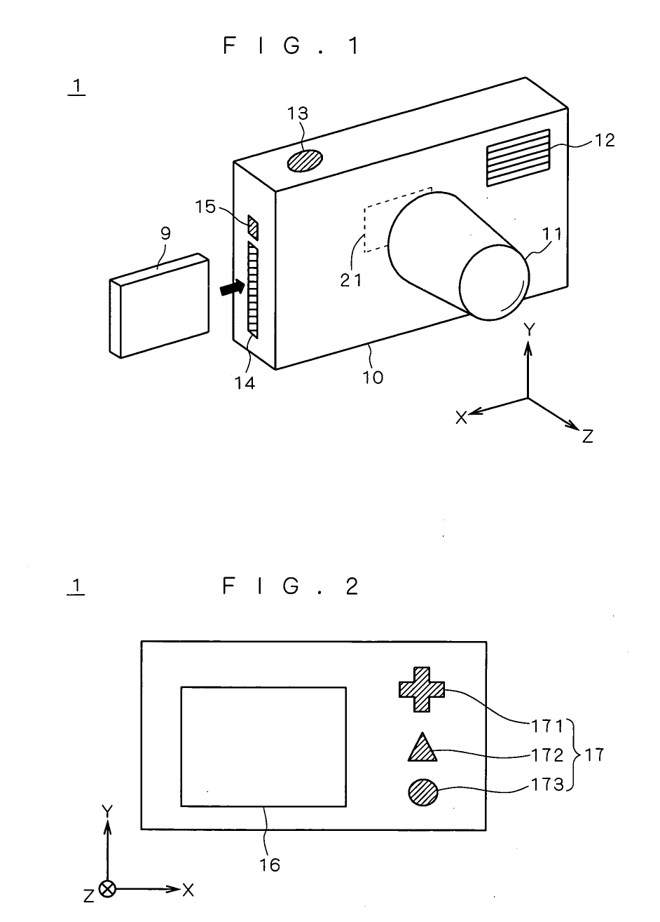

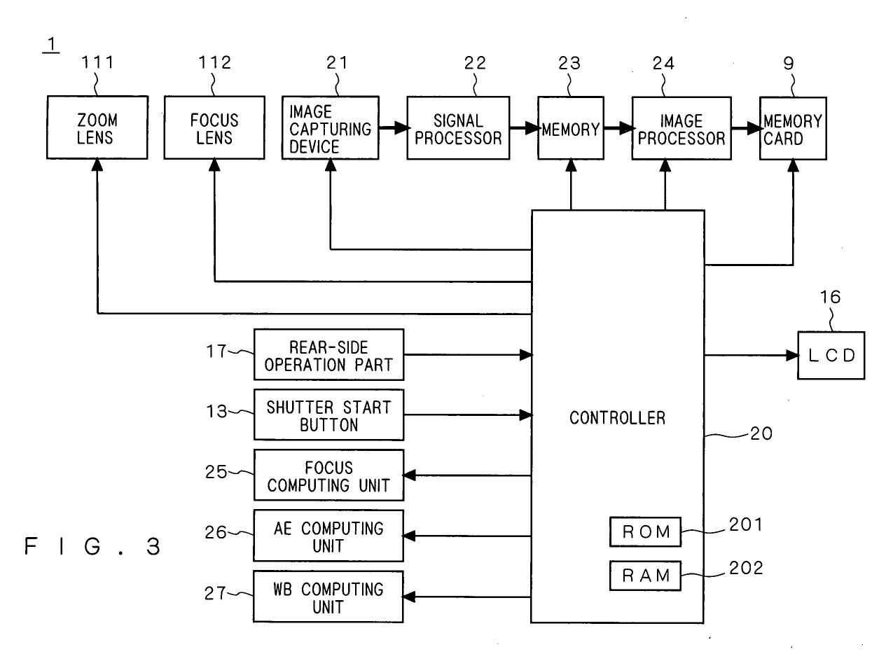

FIG. 1 is a perspective view showing an image capturing apparatus 1 according to a preferred embodiment of the present invention. FIG. 2 is a rear view of the image capturing apparatus 1. In FIGS. 1 and 2, three axes X, Y, and Z which are orthogonal to each other are shown to clarify the directional relations.

The image capturing apparatus 1 is constructed as, for example, a digital camera and a taking lens 11 and an electronic flash 12 are provided in the front face of a camera body 10. On the rear side of the taking lens 11, an image capturing device 21 for photoelectrically converting a subject image entering via the taking lens 11 and generating a color image signal is provided. In this preferred embodiment, a C-MOS type image capturing device is used as the image capturing device 21.

The taking lens 11 includes a zoom lens 111 and a focus lens 112 (refer to FIG. 3). By driving the lenses in the optical axis direction, zooming and focusing of a subject image formed on the image capturing device 21 can be realized.

A shutter start button 13 is provided on the top face of the image capturing apparatus 1. The shutter start button 13 receives an image capturing instruction of the user and is constructed as a two-level switch capable of detecting a half-pressed state (S1 state) and a depressed state (S2 state).

In a side face of the image capturing apparatus 1, a card slot 14 into which a memory card 9 for recording image data obtained by image capturing operation performed by an operation of depressing the shutter start button 13 is inserted is formed. Further, in the side face of the image capturing apparatus 1, a card ejection button 15 operated to eject the memory card 9 from the card slot 14 is disposed.

In a rear face of the image capturing apparatus 1, a liquid crystal display (LCD) 16 for displaying a live view of a subject in a moving image mode before image capturing and displaying a captured image, and a rear-side operation part 17 for changing various setting states of the image capturing apparatus 1 such as shutter speed and zooming are provided.

The rear-side operation part 17 is constructed by a plurality of operation buttons 171 to 173. For example, by an operation on the operation button 171, zooming operation, exposure setting, and the like can be performed. By an operation on the operation button 173, a flashlight image capturing mode and a moving image capturing mode can be set.

FIG. 3 is a diagram showing functional blocks of the image capturing apparatus 1. In the following, functions of the components will be described according to the sequence of still image capturing.

First, when a controller 20 detects the half-press state (S1) of the shutter start button 13, an AE computing unit 26 computes a proper exposure amount for the whole image and sets shutter speed and the gain of an amplifier in a signal processor 22.

After completion of the computation in the AE computing unit 26, a white balance (WB) computing unit 27 computes a proper WB set value and an image processor 24 sets an R gain and a G gain for performing white balance correction.

After completion of the computation in the WB computing unit 27, the focus computing unit 25 computes an AF evaluation value used for AF, for example, in a contrast-method. Based on the result of computation, the controller 20 controls driving of the focus lens 112 to achieve focus on a subject. Concretely, a focus motor (not shown) is driven to detect a lens position in which a high frequency component of an image generated by the image capturing device 21 becomes the peak and moves the focus lens 112 to the position.

Next, when the shutter start button 13 is depressed, a subject light image is formed on the image capturing device 21 through the zoom lens 111 and the focus lens 112, and an analog image signal of the subject is generated. The analog image signal is converted to a digital signal by A/D conversion in the signal processor 22 and the digital signal is temporarily stored in a memory 23.

Image data temporarily stored in the memory 23 is subjected to image processing such as γ conversion by the image processor 24 and stored in the memory card 9. Image data subjected to the image processing in the image processor 24 is processed so as to be displayed on the LCD 16, and the resultant image is displayed on the LCD 16. Consequently, the user can recognize a captured image. In the case where the moving image capturing mode is set, the operation is repeated until the shutter start button 13 is released.

In the case where the shutter start button 13 is half-pressed, an image captured by the image capturing device 21 is subjected to the signal processing and image processing and, after that, displayed in the moving image mode on the LCD 16. By displaying a live view of the subject, the composition can be checked and the angle of view can be changed by operating the operation button 171 while visually recognizing an image of the subject. In this case, when zooming operation by the operation button 171 is detected by the controller 20, the zoom lens 111 is driven and the angle of view desired by the user is set. In the image capturing device 21 of the image capturing apparatus 1, driving at 90 fps (frame per second) is possible as will be described later. At the time of displaying a live view, an image is updated at a frequency of once per three frames in the LCD 16.

The sequence of the still image capturing of the image capturing apparatus 1 described above is executed when the controller 20 controls the components in a centralized manner.

The controller 20 has a CPU and also a ROM 201 and a RAM 202. Various control programs for controlling the image capturing apparatus 1 are stored in the ROM 201. The controller 20 functions as image capture control means which obtains a plurality of images while changing a light emission amount of the electronic flash 12 each time the image capturing device 21 is driven as will be described later.

The image capturing operation of the image capturing apparatus 1 will be described in detail below.

Image Capturing Operation of Image Capturing Apparatus

First, a moving image capturing operation in the image capturing apparatus 1 will be briefly described.

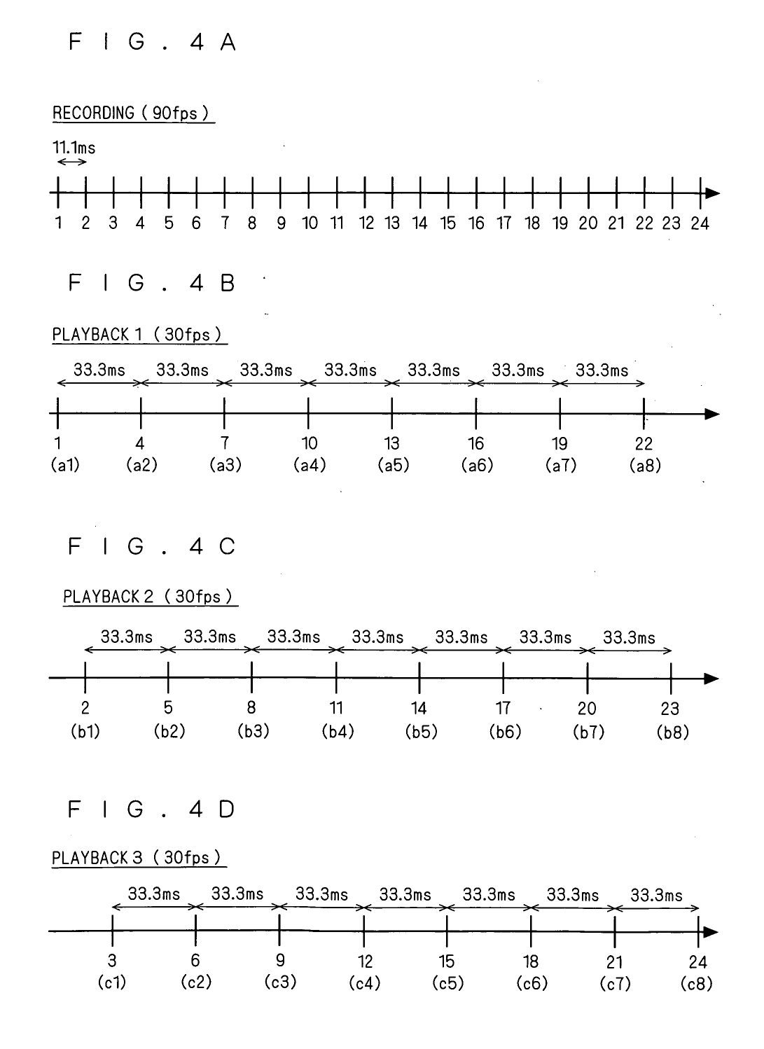

FIGS. 4A to 4D are diagrams illustrating the moving image capturing operation and playback operation in the image capturing apparatus 1. In FIGS. 4A to 4D, the horizontal axis indicates the time base.

As shown in FIG. 4A, the image capturing device 21 in the image capturing apparatus 1 can capture a moving image at 90 fps, that is, at the time interval between frames of about 11.1 ms. Consequently, the image capturing device 21 can be driven at a frame rate which is three times as high as the display frame rate (30 fps) used at the time of displaying a moving image is displayed on the LCD 16. The numerals 1, 2, 3, . . . in FIG. 4A are frame numbers. The larger the number is, the later the image is captured.

When a moving image recorded at a frame rate higher than the display frame rate is played back at a general frame rate of 30 fps (the time interval between frames is about 33.3 ms), the moving image can be sufficiently regarded as a moving image when seen by human eyes. The image capturing apparatus 1 consequently reduces frame images recorded at 90 fps to ⅓ and plays back the reduced images.

Concretely, as shown in FIG. 4B, images of frame numbers 1, 4, 7, . . . , that is, 3n−2 (n: natural number) are extracted from a group of frames (Nos. 1 to 24) shown in FIG. 4A and played back as a moving image. In the following, for convenience of explanation, images of frame numbers 1, 4, 7, . . . will be called a group of images of a series “a” and will be also indicated as a1, a2, a3, . . . .

As shown in FIG. 4C, images of frame numbers 2, 5, 8, . . . , that is, 3n−1 (n: natural number) are extracted from the group of frames (Nos. 1 to 24) shown in FIG. 4A and played back as a moving image. In the following, for convenience of explanation, images of frame numbers of 2, 5, 8, . . . will be called a group of images of a series “b” and will be also displayed as b1, b2, b3, . . . .

As shown in FIG. 4D, images of frame numbers of 3, 6, 9, . . . , that is, 3n (n: natural number) are extracted from the group of frames (Nos. 1 to 24) shown in FIG. 4A and played back as a moving image. In the following, for convenience of explanation, images of frame numbers of 3, 6, 9, . . . will be called a group of images of a series “c” and will be also indicated as c1, c2, c3, . . . .

As described above, the image capturing apparatus 1 can simultaneously obtain the image groups of the series “a” to “c” by a single image capturing operation. By performing image capturing on the series of “a” to “c” with different image capturing conditions, three kinds of moving images can be obtained.

In the image capturing apparatus 1, the moving image capturing can be performed at the frame rate of 30 fps corresponding to moving image display in addition to the high frame rate of 90 fps, and the frame rates can be switched. In the image capturing apparatus 1, the frame rate of 30 fps is usually set.

In the moving image capturing in the image capturing apparatus 1, the image capturing device 21 can be driven at the high frame rate of 90 fps. Also in still image capturing, by performing continuous image capturing by sequentially driving the image capturing device 21 at the high frame rate, a high-quality synthetic image can be generated. This will be described concretely below.

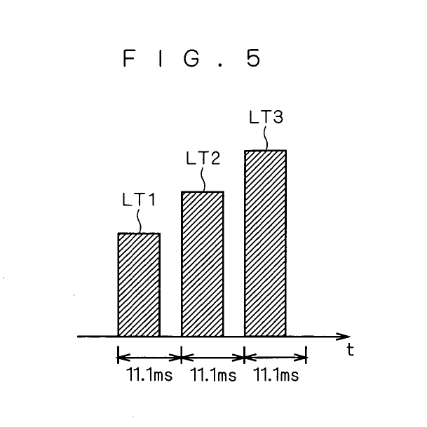

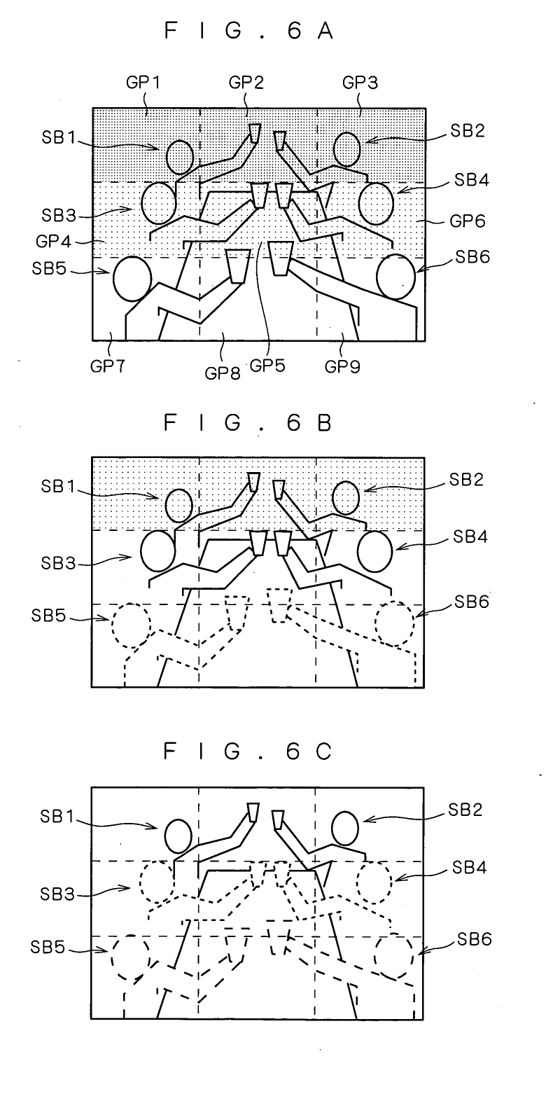

FIG. 5 is a diagram for describing image capturing with flashlight in the image capturing apparatus 1.

Generally, when a plurality of people are photographed with flashlight in a room having a large depth, there is a case such that the exposure level on some people is not proper.

Consequently, the image capturing apparatus 1 successively captures three images with different exposure conditions while changing the light emission amount of the electronic flash 12 each time the image capturing device 21 is driven at timings based on the high frame rate. By synthesizing the images, a synthetic image in which the exposure amount is proper entirely is generated.

Concretely, image capturing accompanying light emission of the electronic flash 12 is sequentially performed at the time intervals of 90 fps and the light emission amount is changed in three levels so as to increase in order of a light emission amount LT1 of the first time, a light emission amount LT2 of the second time, and a light emission amount LT3 of the third time. The light emission amount LT2 of the second time is a light emission amount necessary to make an average exposure amount of a whole screen proper by making the electronic flash 12 preliminarily emit light and adjusting the light. By increasing/decreasing the light emission amount around the light emission amount LT2 as a center, the light emission amounts LT1 and LT3 are obtained.

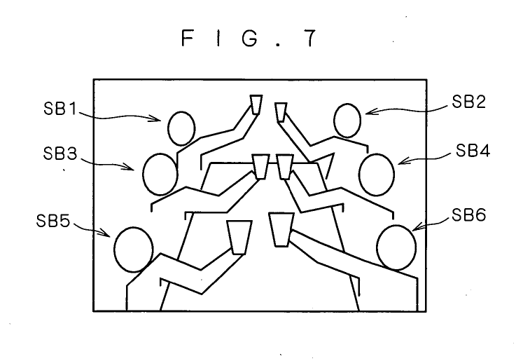

FIGS. 6A to 6C are diagrams illustrating images captured by the image capturing with flashlight. In each of the images shown in FIGS. 6A to 6C, six persons SB1 to SB6 are taken. Regions GP1 to GP9 shown in FIG. 6A correspond to the regions obtained by dividing the screen into nine portions. Although the reference symbols are not shown, each of the screens of FIGS. 6B and 6C is also divided into the regions GP1 to GP9 in a manner similar to FIG. 6A.

The image shown in FIG. 6A is captured with flashlight of the light emission amount LT1 of the first time shown in FIG. 5, and the exposure amounts on the subjects SB5 and SB6 on the front side are proper. On the other hand, the persons SB3 and SB4 in the center portion and the persons SB1 and SB2 on the deep side are under-exposed.

The image shown in FIG. 6B is captured with flashlight of the light emission amount LT2 of the second time shown in FIG. 5, and the exposure amounts on the persons SB3 and SB4 in the center are proper. The light emission amount LT2 is a light emission amount in which the exposure state of pre-light emission is reflected. Although the average exposure amount on the whole image is proper, the persons SB5 and SB6 on the front side are over-exposed and the persons SB1 and SB2 on the deep side are under-exposed.

The image shown in FIG. 6C is captured with flashlight of the light emission amount LT3 of the third time shown in FIG. 5, and the exposure amounts on the persons SB5 and SB6 on the deep side are proper. However, the persons SB3 and SB4 in the center and the persons SB1 and SB2 on the front side are over-exposed.

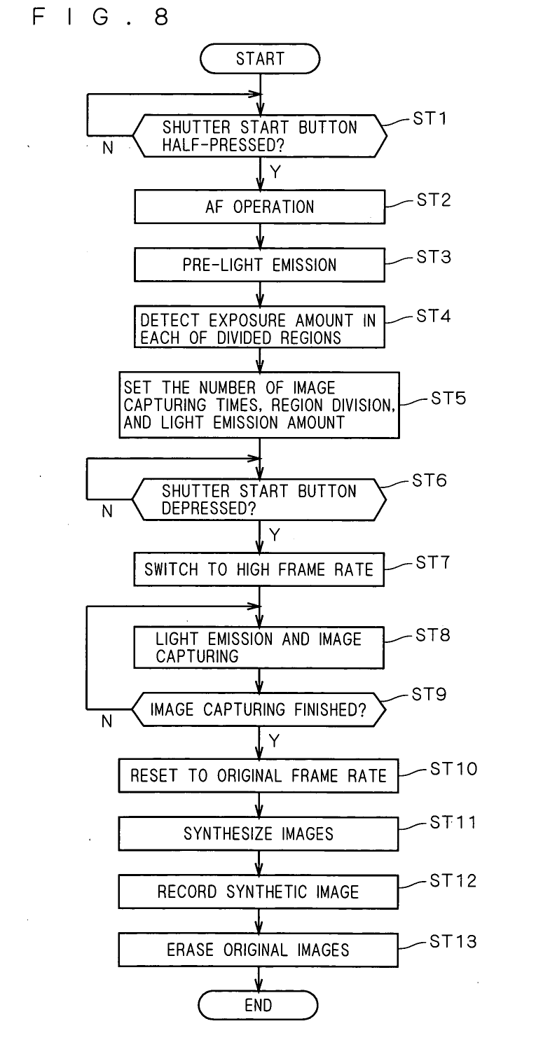

The images shown in FIGS. 6A to 6C are captured by the image capturing with flashlight. By extracting the portions in which the exposure amount is proper from the images and combining the extracted portions, an image shown in FIG. 7 in which the exposure amounts on all of the persons SB1 to SB6 are proper can be generated.

Specifically, from the image of FIG. 6A, the regions GP7 to GP9 in the lower portion of the image, in which the exposure amounts on the subjects SB5 and SB6 are proper, are extracted. From the image of FIG. 6B, the regions GP4 to GP6 in the center portion of the image, in which the exposure amounts on the subjects SB3 and SB4 are proper, are extracted. From the image of FIG. 6C, the regions GP1 to GP3 in the upper portion of the image, in which the exposure amounts on the persons SB1 and SB2 are proper, are extracted. By combining the extracted regions in the image processor 24, the image shown in FIG. 7 in which the exposure amounts on all of the persons are proper is generated. In this case, the series of image capturing operations are performed at the high frame rate as described above and the time required for the image capturing is similar to that for normal one-frame capturing. Consequently, the possibility that subjects move is low and the possibility that the camera shakes is also low. Therefore, without particularly minding the difference from the normal image capturing, the user can perform the image capturing operation of this preferred embodiment.

FIG. 8 is a flowchart showing the image capturing operation with flashlight in the image capturing apparatus 1. The operation is executed by the controller 20.

First, a flashlight image capturing mode is set by an operation on the operation button 173 and, after that, whether the shutter start button 13 is half-pressed by the user or not is determined (step ST1). In the case where the shutter start button 13 is half-pressed, the controller 20 advances to step ST2. In the case where the shutter start button 173 is not half-pressed, the controller 20 repeats step ST1.

In step ST2, an AF operation is performed. Concretely, focus computation is executed by the focus computing unit 25 and the focus lens 112 is moved to the infocus position by the contrast-method AF described above.

In step ST3, pre-light emission of the electronic flash 12 is performed. At this time, an image before the image capturing (image capturing in step ST8) is obtained as an image for exposure detection by the image capturing device 21.

In step ST4, the exposure amount of each of the divided regions is detected. Concretely, the image for exposure detection obtained in step ST3 is divided into the nine regions GP1 to GP9 shown in FIG. 6A and the exposure amount is calculated in each of the regions GP1 to GP9.

In step ST5, the number of image capturing times, region division, and the light emission amount are set. In the following, a concrete example will be described.

First, the maximum and minimum values of exposure amounts in the regions GP1 to GP9 of the image (FIG. 6A) detected by the pre-light emitting operation in step ST3 are detected, and the number of image capturing times is determined according to the difference between the maximum and minimum values.

For example, in the case where the image shown in FIG. 6A is obtained by pre-light emission, the exposure amount of each of the regions GP1 to GP3 is the minimum and the and the exposure amount of each of the regions GP7 to GP9 is the maximum, and three is set as the number of image capturing times according to the difference between the maximum and minimum values.

After the number of image capturing times is determined, the image is divided into regions in correspondence with the number of image capturing times. The image shown in FIG. 6A is divided into three regions corresponding to three times of the number of image capturing times, for example, the three regions GP7 to GP9 in the lower portion of the image corresponding to the maximum exposure amount, the three regions GP1 to GP3 in the upper portion of the image corresponding to the minimum exposure amount, and the three regions GP4 to GP6 in the center portion of the image corresponding to the intermediate exposure amount.

For example, the light emission amounts in three levels as shown by the light emission amounts LT1 to LT3 in FIG. 5 are calculated and set so that photography with flashlight by which the exposure level becomes proper on the basis of the exposure amounts detected from the images captured with pre-light emission can be performed.

In step ST6, whether the shutter start button 13 is depressed by the user or not is determined. In the case where the shutter start button 13 is depressed, the controller 20 advances to step ST7. In the case where the shutter start button 13 is not depressed, the controller 20 repeats step ST6.

In step ST7, the normal frame rate (30 fps) is switched to the high frame rate (90 fps). Specifically, in response to an image capturing instruction to the shutter start button 13, the normal frame rate is switched to the high frame rate.

In step ST8, image capturing is performed with light emission of the electronic flash 12. In this case, light emission with each of the light emission amounts set in step ST5 is performed. For example, the images of different light exposure amounts shown in FIGS. 6A to 6C are captured with light emission of the light amounts LT1 to LT3 shown in FIG. 5. The captured images are stored in the memory 23.

In step ST9, whether the image capturing is finished or not is determined. Concretely, whether the number of image capturing times reaches the number of image capturing times set in step ST5 or not is determined. In the case where the image capturing is finished, the controller 20 advances to step ST10. In the case where the image capturing is not finished, the controller 20 returns to step ST8.

In step ST10, the frame rate switched in step ST7 is reset to the original frame rate (30 fps). That is, after completion of capture of a plurality of images with different exposure conditions, the high frame rate is reset to the original frame rate.

In step ST11, the plurality of images captured in step ST8 are read from the memory 23 and synthesized by the image processor 24. By the operation, for example, portions of the images shown in FIGS. 6A to 6C are combined and an image in which the exposure amounts on all of the persons SB1 to SB6 shown in FIG. 7 are proper is generated.

In step ST12, the image obtained by synthesis in step ST11 is recorded in the memory card (recording means) 9.

In step ST13, the original images are erased. Concretely, the original images to be synthesized in step ST11, that is, all of the three images shown in FIGS. 6A to 6C are erased from the memory (storing means) 23.

By the operations in steps ST1 to ST13, an image on which exposure is proper entirely can be captured in image capturing with flashlight in a room or the like.

In step ST8, at the time of performing image capturing with light emission of the electronic flash 12, infocus may be achieved on a subject in a region in which exposure is proper. For example, when the image shown in FIG. 6A is captured with pre-light emission, the image capturing distance is determined on the basis of the light emission amount of the electronic flash 12 set in step ST5 so that infocus is achieved on each of the persons SB1 and SB2 in the upper portion of the image, the persons SB3 and SB4 in the center portion of the image, and the persons SB5 and SB6 in the lower portion of the image. The focus lens 112 is moved to each of the focus positions corresponding to the image capturing distances and image capturing is performed.

In detection of the focus position, the image capturing distance to each of the persons SB1 and SB2, persons SB3 and SB4, and persons SB5 and SB6 is determined by computation using the principle of “flash-matic” on the basis of data of the f-number (F No.) according to the zoom position, data of the exposure amount of each of the regions (regions GP1 to GP3, regions GP4 to GP6, and regions GP7 to GP9) obtained at the time of pre-light emission, and data of the guide number (G No.) at the time of pre-light emission, and the position of the focus lens 112 according to each of the image capturing distances is determined. The image capturing distance is not necessarily determined by computation but may be determined on the basis of a data table preliminarily stored in the ROM 201 or the like.

By changing the focus on the subject in a region in which proper exposure is desired in the image capturing with flashlight, to be specific, by changing the focus condition according to the image capturing distance in, for example, three levels, a plurality of images in which infocus is achieved on different subjects can be captured. By synthesizing the images, a sharp image in which the exposure level on each of subjects at different image capturing distances is proper and infocus is achieved on each of the subjects can be generated.

By the above-described operations of the image capturing apparatus 1, the frame rate that specifies timings of driving the image capturing device is set to high speed (90 fps), and a plurality of images are sequentially captured while changing the light emission amount of the flashlight step by step and synthesized. As a result, a high-quality synthetic image in which exposure is proper on subjects from the front side to the deep side can be generated in image capturing in a room.

In the image capturing apparatus 1, it is not essential to synthesize three images captured with different light emission amounts of flashlight. For example, three images may be captured with different focus conditions at the high frame rate and synthesized. In this case, a sharp image in which infocus is achieved on all of subjects at different image capturing distances can be generated.

Modifications

In the foregoing preferred embodiment, it is not essential to capture a plurality of images with different exposure conditions by emitting the flashlight. Alternately, a plurality of images may be captured with different exposure conditions while changing the shutter speed or the like without light emission of the flashlight, and synthesized.

In the foregoing preferred embodiment, it is not essential to erase the original images to be synthesized in step ST13 in FIG. 8. For example, the original images may be recorded in the memory card at a compression ratio higher than that of the synthesized image. To be specific, the synthesized image is recorded on the memory card (recording means) 9 at a compression ratio α, and the original images are recorded on the memory card 9 at a compression ratio β higher than the compression ratio α. In such a manner, the image recording capacity can be reduced and the case where the user wishes to use the original image after the image synthesis can be applied.

In the foregoing preferred embodiment, it is not essential to generate a synthetic image as a single still image but a moving image may be generated by repeating the image synthesizing operation. For example, by repeating capturing of three kinds of frame images (FIGS. 6A to 6C) with different light emission amounts at the high frame rate of 90 fps and continuously performing synthesis of the three kinds of frame images, a moving image in which exposure is proper entirely can be obtained. In this case, the original frame images are captured at the frame rate (90 fps) which is three times as high as the display frame rate (30 fps). Consequently, at the time of playing back the moving image constructed by the synthesized frame images, normal playback can be performed.

In the foregoing preferred embodiment, it is not essential to use a CMOS as an image capturing device but a CCD may be also used.

In the foregoing preferred embodiment, it is not essential to perform sequential image capturing at timings based on the frame rate (90 fps) which is three times as high as the display frame rate (30 fps) used at the time of displaying a moving image. It is sufficient to perform sequential image capturing at timings of the high frame rate which is higher than the display frame rate. It is not essential to change the image capturing condition such as the light emission amount of the electronic flash or the like in three levels but it is sufficient to change the image capturing condition in two or more levels. In such a case as well, a plurality of kinds of images can be captured promptly. By synthesizing the images, a high-quality synthetic image can be generated.

In the foregoing preferred embodiment, it is not essential to control the light emission amount of the electronic flash. By controlling the aperture while the light emission amount is set to be constant, the amount of light emitted to the subject may be changed.

While the invention has been shown and described in detail, the foregoing description is in all aspects illustrative and not restrictive. It is therefore understood that numerous modifications and variations can be devised without departing from the scope of the invention.

What is claimed is:

1. An image capturing apparatus having a display device capable of displaying an image, comprising:
(a) an image capturing device which generates an image of a subject;
(b) a driver which sequentially drives said image capturing device at timings based on a high frame rate higher than a display frame rate used at the time of displaying a moving image on said display device;
(c) an image capturing controller which sequentially captures two or more images while changing an image capturing condition each time said image capturing device is driven by said driver; and
(d) a synthesizer which synthesizes said two or more images, thereby generating a synthetic image, wherein
with respect to changing in said image capturing condition by said image capturing controller, said image capturing condition is changed in two or more levels.

2. The image capturing apparatus according to claim 1, further comprising:
(e) an emission setting part which sets a light emission amount of an electronic flash in said two or more levels, wherein
said image capturing condition includes a condition regarding said light emission amount of said electronic flash.

3. The image capturing apparatus according to claim 2, further comprising:
(f) a distance obtaining part which obtains an image capturing distance on the basis of said light emission amount of said electronic flash, which is set by said emission setting part, wherein
said image capturing condition also includes a focus condition according to said image capturing distance.

4. The image capturing apparatus according to claim 1, wherein
said image capturing controller includes:
(c-1) a storage controller which makes said two or more images stored into a storing part, and
said synthesizer includes:
(d-1) a recording controller which records said synthetic image into a predetermined recording part; and
(d-2) an eraser which erases said two or more images stored in said storing part.

5. The image capturing apparatus according to claim 1, wherein said synthesizer includes:
(d-3) a first recording controller which makes said synthetic image recorded into a recording part at a predetermined compression ratio; and
(d-4) a second recording controller which makes said two or more images recorded into said recording part at a compression ratio higher than said compression ratio.

6. The image capturing apparatus according to claim 2, further comprising:
(g) a pre-light emitting part which captures an image obtained with pre-light emission of said electronic flash as an image for exposure detection by said image capturing device before said two or more images are captured by said image capturing controller; and
(h) a detector which divides said image for exposure detection into a plurality of regions and detects an exposure amount in each of divided regions, wherein said emission setting part includes:
(e-4) a level setting part which sets said light emission amount of said electronic flash in said two or more levels on the basis of said exposure amount of each of said divided regions detected by said detector.

7. The image capturing apparatus according to claim 1, further comprising:
(i) a receiving part which receives an image capturing instruction to activate said image capturing controller; and
(j) a frame rate setting part which sets a frame rate specifying drive timings of said image capturing device, wherein
said frame rate setting part includes:
(j-1) a switching part which switches said frame rate to said high frame rate in response to said image capturing instruction.

8. The image capturing apparatus according to claim 7, wherein
said frame rate setting part further includes:
(j-2) a resetting part which resets said high frame rate to said display frame rate after capturing of said two or more images by said image capturing controller is finished.

9. An image capturing method using an image capturing device which generates an image of a subject, the method comprising the steps of:
(a) sequentially driving said image capturing device at timings based on a high frame rate higher than a display frame rate used at the time of displaying a moving image on a display;
(b) sequentially capturing two or more images while changing an image capturing condition each time said image capturing device is driven in said step (a); and
(c) synthesizing said two or more images, thereby generating a synthetic image, wherein
with respect to changing in said image capturing condition in said step (b), said image capturing condition is changed in two or more levels.
